(19) United States
(12) Patent Application Publication
(10) Pub. No.: US 2008/0254790 A1
(43) Pub. Date: Oct. 16, 2008

(54) TELECOMMUNICATIONS SYSTEMS AND METHODS FOR WIRELESS E-911 CALL TESTING

(76) Inventors: Eric Baldridge, Alpharetta, GA (US); Lien Dao, Lawrenceville, GA (US); Dave Koons, Dacula, GA (US)

Correspondence Address: CLEMENTS BERNARD MILLER, 1901 ROXBOROUGH ROAD, SUITE 300, CHARLOTTE, NC, 28211, US

(21) Appl. No.: 11/734,586

(22) Filed: Apr. 12, 2007

(51) Int. Cl. H04B 17/00; H04M 3/28

(52) U.S. Cl. 455/424; 379/1.03

(57) ABSTRACT

The technology described herein provides systems and methods for remote emergency wireless E-911 call testing. The wireless E-911 call testing system includes a remote call testing unit (RCTU) which, in combination with an Automated Emergency Operator Server (AEOS), allows for verification of 911 call functionality without the need for in-person, on-site testing at each cellular site.

### FIELD OF THE INVENTION

The technology described herein relates generally to wireless E-911 systems and methods. More specifically, the technology relates to systems and methods for remote emergency wireless E-911 call testing. The wireless E-911 call testing system includes a remote call testing unit (RCTU) which, in combination with an Automated Emergency Operator Server (AEOS), allows for verification of 911 call functionality without the need for in-person, on-site testing at each cellular site.

### BACKGROUND OF THE INVENTION

The Wireless Communications and Public Safety Act of 1999 directs the Federal Communications Commission (FCC) to require an enhanced 911, or E-911, service that automatically associates a physical location address with the telephone number of the calling party. The E-911 system provides emergency response personnel with the location of a caller, and thus the site of the actual emergency, in such a manner that the person calling for help from a wireless device does not have to verbally provide location information. The caller's location is identified, for example, through the use of radiolocation from the cellular network or by a global positioning system (GPS) capability within the wireless phone.

A caller using a wireless device, such as a cellular telephone, has phone service provided by a wireless carrier. When a wireless 911 call is made by the caller on the wireless device, the wireless carrier must know to which Public Safety Answering Point (PSAP) that call is to be routed. A PSAP is a public service agency that answers 911 calls for emergency assistance. There are several thousand PSAPs, to which such emergency calls may be routed, located throughout the United States. Once a specific PSAP receives an emergency 911 call routed from the wireless carrier, the PSAP must know exactly where the caller is located geographically in order to quickly dispatch emergency service personnel to that location.

To ensure that such 911 systems are functioning properly, significant testing is utilized. In order to verify that a private sector portion of an E-911 system is functioning properly, a wireless carrier must call test the 911 functionality on each cellular site whenever there are augmentations to the site location and/or data within its network. Each time these call tests are done, it is required that a team of testers drive to each cell site affected and make an E-911 test call to verify 911 call functionality. The test process is cumbersome. PSAPs require wireless carriers to notify them when such a test will take place. Additionally, PSAPs require that such tests be done at the PSAP's convenience in order to not overburden the PSAP staffing.

A wireless 911 call testing system is desired wherein no field personnel are required to drive to each cell site, and wherein the cell sites thus are remotely call tested. Additionally, a call testing system is desired wherein an emergency operator is not needed as a participant in the test and no scheduling with the PSAP is required.

A variety of innovations related to 911 systems and methods have been described previously and are well known in the related art. None of these systems or methods, however, is designed to solve the particular problems addressed by the technology described herein, and none is capable of easily being modified to do so.

For example, U.S. Pat. No. 6,792,080, issued to Imperato et al. on Sep. 14, 2004 discloses a method and system for automatically testing E911 systems using digital loop carrier trunks in a laboratory. A testbed running a testing program evaluates the functionality of a digital loop carrier trunk, a channel unit pair, and an E911 switch by measuring a delay and duration of an acknowledgement pulse from the E911 switch in response to an off-hook condition at a simulated PBX. The testbed and testing program also evaluate the functionality of the E911 switch and a simulated PSAP by measuring a delay and duration of a ring signal from the E911 switch in response to an emergency signal sent by the simulated PBX. Once connection between the simulated PBX and the simulated PSAP has been established, the end-to-end signal loss is also measured.

U.S. Pat. No. 6,956,930, issued to Cook on Oct. 18, 2005 discloses an apparatus, and an associated method, for facilitating service handling of a call placed to a public safety answering point using a universal dialing code, such as an emergency 9-1-1 dialing code. A centralized routing database is formed and maintained. When a call is originated and routed to a call routing entity, the centralized routing data base is accessed to obtain the identity of the public safety answering point to which to route the call. Thereby, a call connection is formed to an appropriate public safety answering point. Due to the centralized nature of the routing data base, updates to the data base are readily and easily ascertainable.

U.S. Pat. No. 5,548,583, issued to Bustamante on Aug. 20, 1996 discloses base stations of a wireless telephone user location or position system that are arranged in cell clusters and are mutually synchronized to provide very stable signal timing. A center cell or central base station (BSN) in a cluster of N cells acts as a cluster control center for purposes of user location or position finding and is provided with the capability to process information and derive user position. The other cells in a given cluster transmit received 911 data to the cluster control center. The handsets communicate with the respective cells in the normal fashion. However, when the handset dials “911”, the enhanced 911 (ENH911) operation is initiated and the handset automatically changes its mode of operation: once per master frame there is included a 100 ms burst of a sequence of transmissions of unmodulated overlay PN sequence and Radamacher Walsh (RW) OCDMA code emanating from the handset only. However, other signaling formats may be used. The pattern is repeated once per master frame, the 540 ms interval between successive 100 ms bursts can be normal voice communication. When establishing a 911 call, a message is included in the handset to base station order wire data alerting the base station that a 911 call is in progress. The base stations are provided with matched filter receivers which can process the received OCDMA and overlay PN code spread signals so as to derive accurate time of arrival (TOA) data. At least three base stations within range of the handset are assigned to derive TOA data from the ENH911 signal from the handset and after processing these TOA signals are used to solve triangulation equations and obtain very accurate position or location information.

U.S. Pat. No. 5,873,040, issued to Dunn et al. on Feb. 16, 1999 discloses a system arrangement and method are disclosed for determining location of a wireless mobile unit involved in a call for public emergency assistance (e.g. a “911” call). The system is cost-effective in that it makes extensive use of existing telecommunication infrastructures, and does not require either special hardware or software at either the mobile unit site or the emergency assistance center handling a call. The system features shared use of a computer and specially defined database among a plurality of mobile switching offices serving a larger plurality of mobile base stations, the latter serving an even larger plurality of antenna and transceiving sites within predefined cellular regions. Signal strength measurements at the base stations are passed through the switching offices to a shared computer, and the latter uses the measurements to calculate a small area for which it would be practical to conduct a search if the mobile unit user requiring assistance is unable to help in determining his/her location. The calculated area and database are used to furnish the emergency assistance center handling the call with a detailed mapping of the calculated area, highlighting specific features (terrain, buildings, signs, etc.) that could be used to question the caller in a manner likely to produce responses from which the caller's location could be either precisely fixed or at least narrowed to a small part of the mapped area.

U.S. Pat. No. 6,972,717, issued to Sollenberger et al. on Dec. 6, 2005, discloses a method of locating a mobile telephone includes steps of receiving, transmitting, increasing and determining. In the receiving step, a first base station receives a call from a mobile telephone, the call including a dialed number and a TDMA signal. In the transmitting step, the base station transmits a control message to the mobile telephone when the dialed number meets a predetermined criterion, such as being 911. The control message instructs the mobile telephone to transmit the TDMA signal at a maximum power. In the increasing step, the mobile telephone increases the TDMA signal to maximum power in response to the control message. Then in the determining step, location information for the mobile telephone is determined based on at least one characteristic of the TDMA signal received at least one of the first base station and other base stations. In an alternate embodiment, the method is practiced in a mobile telephone and the power level is automatically increased in response to the dialed number meeting a predetermined criterion.

U.S. Pat. No. 6,947,755, issued to Gould et al. on Sep. 20, 2005, discloses systems and methods for distributed processing of location information with emergency 911 wireless transmissions. Disclosed are systems and methods to locate and recover objects equipped with tracking devices by determining the location information of the object. The system employs multiple radio direction-finding (RDF) devices, which is capable of determining the angle of arrival of a radio signal. The MSC sends a request along with radio information to a location processor, which controls the RDF devices. The system also employs a theft detection device, which is capable of placing a wireless telephone call to a monitoring center. The theft detection device connects to and receives instructions from the monitoring center, which retrieves the instructions from a primary database server. If the primary database server is unavailable, the request for information is sent to a secondary database server.

U.S. Pat. No. 7,058,389, issued to Chin et al. on Jun. 6, 2006, discloses a method of communicating emergency call information originating from wireless phones among multiple entities using a set of network signaling operations for pooling and reconciling records of emergency calls and identifications for sources of fraudulent calls. A set of network signaling operations is described herein for communicating records of emergency calls among network entities of same or different levels, and for communicating identified sources of fraudulent calls among network entities of same or different levels.

None of these systems or methods discloses a wireless 911 call testing system wherein no field personnel are required to drive to each cell site, and wherein the cell sites thus are remotely call tested. Additionally, none of these systems or methods discloses a call testing system wherein an emergency operator is not needed as a participant in the test and no scheduling with the PSAP is required. Therefore, a need still exists for such a system as the one described herein.

### BRIEF SUMMARY OF THE INVENTION

In various exemplary embodiments, the technology described herein provides systems and methods for remote emergency wireless E-911 call testing. The wireless E-911 call testing system includes a remote call testing unit (RCTU) which, in combination with an Automated Emergency Operator Server (AEOS) located, for example, at a Public Safety Answering Point (PSAP), allows for verification of 911 call functionality without the need for in-person, on-site testing at each cellular site. The AEOS is optionally implemented at sites other than a PSAP, as is appreciated by those skilled in the art.

In one exemplary embodiment, the technology described herein provides a wireless E-911 call-testing method, for verifying 911 call functionality without the need for in-person, on-site testing at each cellular site in a wireless carrier network. This method includes: initiating a test call from a remote location by accessing a number assigned to a remote call-testing apparatus, the remote call-testing apparatus located within a wireless carrier's cellular tower site base station to automatically answer an incoming emergency 911 test call, dial 911 in a new call, combine the two calls into a single combined call, and to subsequently reroute the combined call to a Public Safety Answering Point (PSAP); answering automatically the test call at the remote call-testing apparatus; dialing 911 in a new call at the remote call-testing apparatus; combining the test call and the 911 call into a single call at the remote call-testing apparatus; and routing the combined call to a Public Safety Answering Point (PSAP). This verification of 911 call functionality is completed without the need for in-person, on-site testing at each cellular site.

The wireless E-911 call-testing method also includes: answering automatically the test call with a mobile phone unit located within the remote call-testing apparatus; dialing 911 in a new call with a processor located within the remote call-testing apparatus; combining the test call and the 911 call into a single call with the processor located within the remote call-testing apparatus; and rerouting the combined call to a Public Safety Answering Point (PSAP) with the processor located within the remote call-testing apparatus.

The wireless E-911 call-testing method also includes: utilizing an Automated Emergency Operator Server (AEOS), to electronically and automatically act as an emergency operator having access to E911 critical databases. The AEOS is contacted by the RCTU via a unique a routing number over a dedicated trunk.

The wireless E-911 call-testing method also includes: identifying, at the AEOS, the call-back number and the E911 location data from an existing PSAP database and transmitting, from the AEOS, the E911 location data via a web client to a graphical user interface (GUI) for the call tester to verify.

The wireless E-911 call-testing method also includes: presenting, via the AEOS and a return data path, the following E911 data to a user/call tester: a unique routing number, a physical address of the RCTU, a latitude and a longitude of the RCTU, and a calling number of the call tester.

The wireless E-911 call-testing method also includes: establishing a voice channel, via the public switched telephone network (PSTN); representing the voice channel in a return path for voice channel setup verification; and transmitting a verification to the test caller verifying voice channel integrity.

In another exemplary embodiment, the technology described herein provides a wireless E-911 call-testing method, for verifying 911 call functionality without the need for in-person, on-site testing at each cellular site in a wireless carrier network. This method includes: initiating a test call from a remote location by accessing a number assigned to a remote call-testing apparatus, the remote call-testing apparatus located within a wireless carrier's cellular tower site base station to automatically answer an incoming emergency 911 test call, dial 911 in a new call, combine the two calls into a single combined call, and to subsequently reroute the combined call to a Public Safety Answering Point (PSAP); answering automatically the test call at the remote call-testing apparatus and placing the test call on hold; placing the test call on hold via an AT command string at the remote call-testing apparatus; and prompting audibly a test caller to select one of two options, wherein the test caller selects one of: entering 1, to execute a test call, or entering 2, to provide the test caller with an SMS message from the remote call-testing apparatus displaying test results data from the wireless carrier's cellular tower site.

The wireless E-911 call-testing method also includes: answering automatically the test call with a mobile phone unit located within the remote call-testing apparatus; placing, with a processor located within the remote call-testing apparatus, the test call on hold via an AT command string at the remote call-testing apparatus; and prompting, with a processor located within the remote call-testing apparatus, audibly a test caller to select one of two options, wherein the test caller selects one of: entering 1, to execute a test call, or entering 2, to provide the test caller with an SMS message from the remote call-testing apparatus displaying test results data from the wireless carrier's cellular tower site.

The wireless E-911 call-testing method also includes: selecting 1, by the test caller when prompted, thus executing a test call process; prompting the test caller with one of one of a prerecorded message or a tone or a tone, issued by the remote call-testing apparatus, to enter a 10-digit number, the number being a telephone number to be tested; entering the 10-digit number, by the test caller; removing, at the remote call-testing apparatus, the automatically answered test call from hold; executing, at the remote call-testing apparatus, AT command functions and combining the automatically answered test call and a call with the 10-digit number entered; confirming, at the remote call-testing apparatus, whether the combined call was completed successfully; and routing, at the remote call-testing apparatus, the combined call to a Public Safety Answering Point (PSAP) operator.

The wireless E-911 call-testing method also includes: selecting 2, by the test caller when prompted, thus initiating a test call process; prompting the test caller with a one of a prerecorded message or a tone, issued by the remote call-testing apparatus, to enter a 10-digit number, the number being a telephone number of a calling device of the test caller to which the caller wishes to receive an SMS message; entering the 10-digit number, by the test caller; initiating, at the remote call-testing apparatus, the SMS message, using AT command strings; sending, from the remote call-testing apparatus, the SMS message to the entered 10-digit number, the SMS message containing CGI data and signal levels of the wireless carrier's cellular tower site base station.

The wireless E-911 call-testing method also includes: selecting 1, by the test caller when prompted, thus executing a test call process; prompting the test caller with a one of a prerecorded message or a tone, issued by the remote call-testing apparatus, to enter a 10-digit number, the number being a telephone number to be tested; entering the 10-digit number, by the test caller; removing, at the remote call-testing apparatus, the automatically answered test call from hold; executing, at the remote call-testing apparatus, AT command functions and combining the automatically answered test call and a call with the 10-digit number entered; confirming, at the remote call-testing apparatus, whether the combined call was completed successfully; routing, at the remote call-testing apparatus, the combined call to a an Automated Emergency Operator Server (AEOS), to electronically and automatically act as an emergency operator having access to E911 critical databases; and routing to a Public Safety Answering Point (PSAP) operator when the AEOS is offline or otherwise unavailable.

In another exemplary embodiment, the technology described herein provides a wireless E-911 call-testing system, for verifying 911 call functionality without the need for in-person, on-site testing at each cellular site in a wireless carrier network. The system includes: a remote call-testing apparatus, the remote call-testing apparatus located within a wireless carrier's cellular tower site base station to automatically answer an incoming emergency 911 test call, dial 911 in a new call, combine the two calls into one, and to subsequently reroute the combined call to a Public Safety Answering Point (PSAP); and a remote calling device, the remote calling device selectively connected to the remote call-testing apparatus to conduct the incoming emergency 911 test call. Verification of 911 call functionality is completed without the need for in-person, on-site testing at each cellular site.

The wireless E-911 call-testing system also includes: a remote call-testing apparatus that includes: one or more of a mobile phone unit (MPU), located within the remote call-testing apparatus, the one or more MPU being operative to automatically answer an incoming emergency 911 test call; and a processor, located within the remote call-testing apparatus, the processor to perform AT command functions to place the incoming emergency 911 test call on hold, dial 911, and subsequently join both calls.

The wireless E-911 call-testing system also includes: an Automated Emergency Operator Server (AEOS), and to electronically and automatically act as an emergency operator having access to E911 critical databases. The AEOS is contacted by the RCTU via a unique a routing number over a dedicated trunk The AEOS returns, via a data path, presenting the following E911 data to a user/call tester: a unique routing number, a physical address of the RCTU, a latitude and a longitude of the RCTU, and a calling number of the call tester.

The wireless E-911 call-testing system also includes a call-testing apparatus that includes: one or more of an antenna connector; and one or more of an antenna feed, entering the remote call-testing apparatus through the one or more of an antenna connector. The one or more of an antenna feed electronically connects to the one or more of a mobile phone unit (MPU), located within the remote call-testing apparatus.

The wireless E-911 call-testing system also includes a remote call-testing apparatus that includes a cooling fan unit, located with remote call-testing apparatus, providing cool air to the one or more mobile phone units (MPU), located within the remote call-testing apparatus, and the processor, located within the remote call-testing apparatus. The wireless E-911 call-testing system also includes a remote call-testing apparatus that includes a power supply, the power supply providing power to the MPUs and to the processor located within the remote call-testing apparatus.

Advantageously, this wireless 911 call testing system overcomes many of the deficiencies known in the art pertaining to 911 systems. Additionally, the wireless 911 call testing system provides a cost-effective solution to remotely call testing cell sites without the need for field personnel having to drive to each tested cell site. Furthermore, the wireless 911 call testing system provides a testing solution wherein an emergency operator is not needed as a participant in the test and no scheduling with the PSAP is required.

There has thus been outlined, rather broadly, the features of the technology described herein in order that the detailed description that follows may be better understood, and in order that the present contribution to the art may be better appreciated. There are additional features of the technology described herein that will be described and which will form the subject matter of the claims. In this respect, before explaining at least one embodiment of the technology described herein in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the technology described herein.

Additional aspects and advantages of the technology described herein will be apparent from the following detailed description of an exemplary embodiment which is illustrated in the accompanying drawings.

### BRIEF DESCRIPTION OF THE DRAWINGS

The technology described herein is illustrated and described herein with reference to the various drawings, in which like reference numbers denote like method steps and/or system components, respectively, and in which:

FIG. 1 is a schematic diagram illustrating a wireless E-911 call testing system according to an embodiment of the invention, illustrating, in particular, the remote call testing unit and the automated emergency operator server;

FIG. 2 is a schematic diagram illustrating a remote call testing unit according to an embodiment of the invention, illustrating, in particular, the mobile phone units and the processor;

FIG. 3 is a schematic diagram illustrating the remote call testing unit of FIG. 2 from the rear view, illustrating in particular the snap-on connectors and the external antenna feeds;

FIG. 4 is a flowchart diagram illustrating a wireless E-911 call testing method according to an embodiment of the invention, illustrating, in particular, the unavailability of or the integration failure of an automated emergency operator server;

FIG. 5 is a flowchart diagram illustrating a wireless E-911 call testing method according to an embodiment of the invention, illustrating, in particular, the integration of the automated emergency operator server;

FIG. 6 is a flowchart diagram illustrating a wireless E-911 call testing method according to an embodiment of the invention, illustrating, in particular, the integration of the automated emergency operator server; and

FIG. 7 is a flowchart diagram illustrating a wireless E-911 call testing method according to an embodiment of the invention, illustrating, in particular, the unavailability of or the integration failure of an automated emergency operator server;

### DETAILED DESCRIPTION OF THE INVENTION

Before describing the disclosed embodiments of the technology described herein in detail, it is to be understood that the technology is not limited in its application to the details of the particular arrangement shown here since the technology is capable of other embodiments. Also, the terminology used herein is for the purpose of description and not of limitation.

In various exemplary embodiments, the technology described herein provides systems and methods for remote emergency wireless E-911 call testing. To ensure that such 911 systems are functioning, significant testing is utilized. In order to verify that a private sector portion of an E-911 system is functioning properly, a wireless carrier must call test the 911 functionality on each cellular site whenever there are augmentations to the site location and/or data within its network. The wireless E-911 call testing system 100 includes a remote call testing unit (RCTU) 120 which, in combination with an Automated Emergency Operator Server (AEOS) 162 located at a Public Safety Answering Point (PSAP) 160, allows for verification of 911 call functionality without the need for in-person, on-site testing at each cellular site.

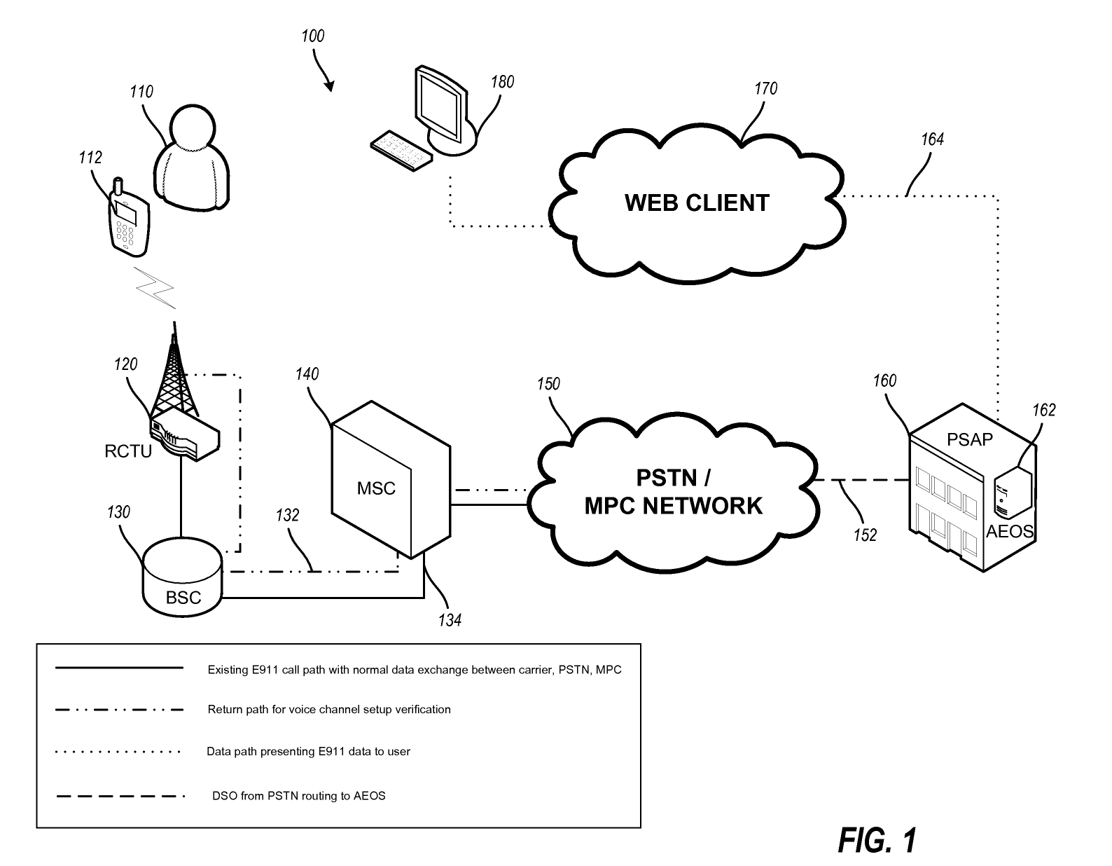

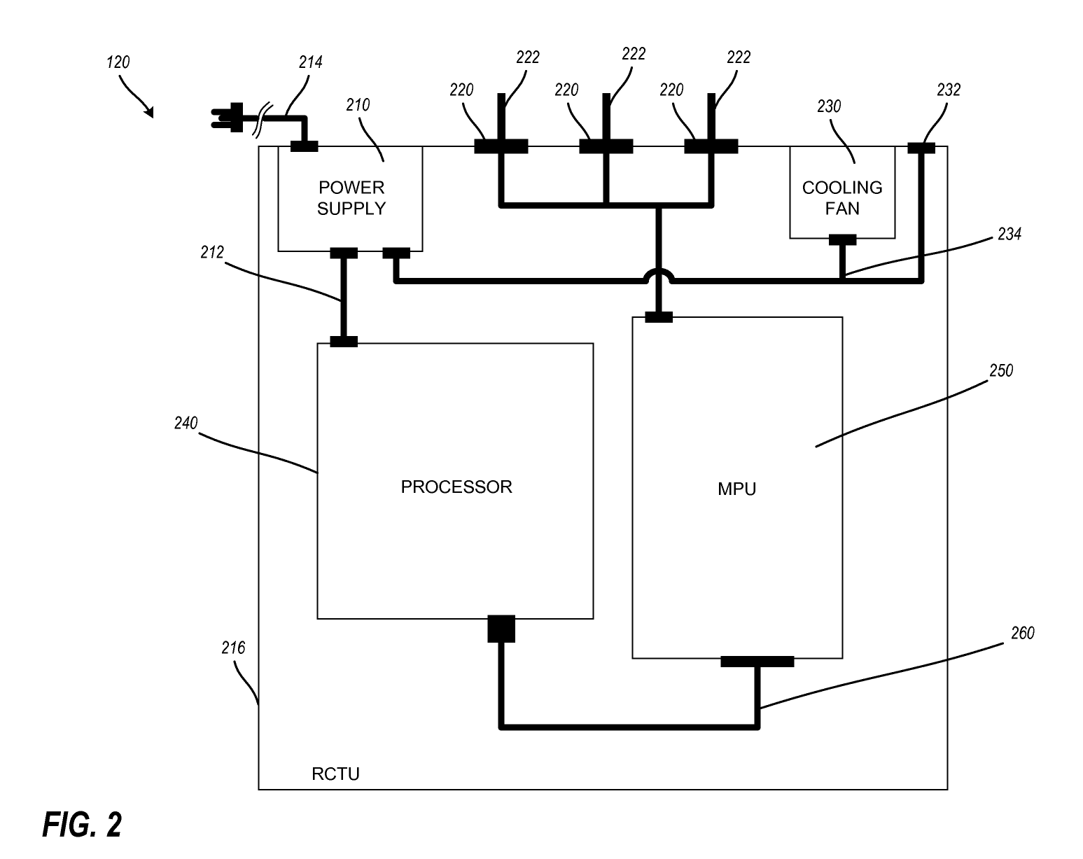

Referring now to FIG. 1, a wireless E-911 call testing system 100 is shown. The wireless E-911 call testing system 100 includes a Remote Call Testing Unit (RCTU) 120 located at a wireless carrier's cellular tower site. The RCTU 120 is, for example, housed in a rack mount within the cabinet of the wireless carrier's cell site. The RCTU 120 includes one or more mobile phone units (MPU) (250 in FIG. 2) located within, and electronically connected to, the RCTU 120. The RCTU 120 also includes a processor (240 in FIG. 2) electronically connected to the MPU(s) 250.

The wireless E-911 call testing system 100 also includes an Automated Emergency Operator Server (AEOS) 162 located at a Public Safety Answering Point (PSAP) 160. The PSAP 160 is a public service agency that answers 911 calls for emergency assistance. The AEOS 162 is located at a PSAP 160, which electronically and automatically acts as an emergency operator having access to E911 critical data bases. Once the AEOS is contacted by the RCTU via a unique a routing number over a dedicated trunk, the AEOS 120 will return via a data path 164 presenting E911 data to a user with a web client 170 the following data to the user/call tester 110: ESRD, physical address of RCTU 120, latitude/longitude of RCTU 120 and calling number of user/call tester 110. To verify an established voice channel the user/call tester 110 will hear an audible tone during the test call. The communication between the RCTU 120 and AEOS 162 will be accomplished over pre-established networks 150.

In a wireless E-911 call test, for example, a user/call tester 110, using a landline or mobile phone 112, dials a 10-digit telephone number of a specific RCTU 120. The RCTU 120 directs the test call to 911 services using the wireless carrier's network, emulating the same experience a wireless customer calling 911 would experience. This existing E911 call path 134 maintains normal data exchange between the carrier, base station controller (BSC) 130, mobile switching center (MSC) 140, Public Switched Telephone Network (PSTN) 150, and the Mobile Positioning Center (MPC) 150. The PSTN 150 subsequently routes, by the RCTU's 120 unique 10 digit number, the E911 call to a single DSO which connects to the AEOS 162 at the targeted PSAP 160 via data path 152. The AEOS 162 collects the call-back number and the E911 location data from existing databases and transmits the E911 data via a web client 170 to a graphical user interface (GUI) 180 for the call tester 110 to verify. The information transmitted to the call tester 110 is the same information, and in the same format, as an emergency operator sees on a terminal. The PSTN 150 establishes a voice channel, the same as in a traditional 911 call. The voice channel is represented in the return path for voice channel setup verification 132. From the AEOS 162 a recording will be sent to the test caller 110 verifying voice channel integrity.

The wireless E-911 call testing system 100 eliminates the need for field personnel to drive to each cellular site to test 911 functionality. The wireless E-911 call testing system 100 also eliminates the need for an emergency operator to be involved in the test since the AEOS 162 will retrieve the call, generate E911 critical data (a unique routing number, physical address of RCTU, latitude/longitude of RCTU and calling number of user/call tester) an supply it to the user/call tester 110. The process will be transparent to the PSAP and, therefore, can take place at any time.

Referring now to FIG. 2, a top view of an uncovered Remote Call Testing Unit (RCTU) 120 is shown. The wireless E-911 call testing system 100 includes such a Remote Call Testing Unit (RCTU) 120 located at a wireless carrier's cellular tower site. The RCTU 120 is, for example, housed in a rack mount case (19 inch) 216 within the cabinet of the wireless carrier's cell site. The RCTU 120 includes one or more mobile phone units (MPU) 250 located within, and electronically connected to, the RCTU 120. In various embodiments more than one MPU 250 is implemented to test a range of wireless technologies, if those technologies are present at the wireless carrier's cellular site. In various embodiments more than one MPU 250 is used to provide for backup and redundancy. In various other embodiments, one MPU 250 is used at each of the wireless carrier's cellular sites when the same wireless technology is used at each wireless sector.

The RCTU 120 also includes a processor 240. The MPU 250 is connected to the processor 240 via a cable 260, such as, for example, a USB or serial cable, within the same 19 inch rack mount unit 216. Also, power is supplied to the MPU 250 through cable 260 from the processor 240. The RCTU 120 is, for example, powered by a standard 120V power supply 210 and 120V power input cable 214. The power supply 210 provides power to the processor 240 and the MPU(s) 250. The RCTU 120 also includes a cooling fan unit 230 powered by the power supply 210 through power cable 234. The RCTU 120 further includes an external power switch 232. Power is provided to the processor 240 by a cable 212 from the power supply 210 to the processor 240. The processor 240 accepts and processes the AT commands (the Hayes Command Set) that are pre-coded in the processor.

By way of AT commands the processor 240 will manipulate the functions of the MPU(s) 250, allowing it to forward calls to any destination number the user/call tester inputs. The RCTU 120, upon a request from the user, will send a message (for example, a text message in Short Message Service (SMS) format) indicating the active sector being seen by the MPU(s) 250, displaying signal strength, sector, and system data. All inputs are prompted via pre-recorded prompts coded into the processor 240. Input from the user/call tester will be accomplished via the touch tone key pad of the user/call tester's phone. The RCTU 120 also includes one or more snap connectors 220, or the like, to accept one or more external antenna feeds 222 that are electronically coupled to each MPU 250. Each RCTU 120, for example, houses three MPUs 250.

In addition to emergency call testing, the RCTU 120, in an alternative embodiment, provides remote call testing for any destination number with which any mobile subscriber is experiencing wireless connectivity trouble. Thus, the destination number, or test number, need not be limited to only 9-1-1.

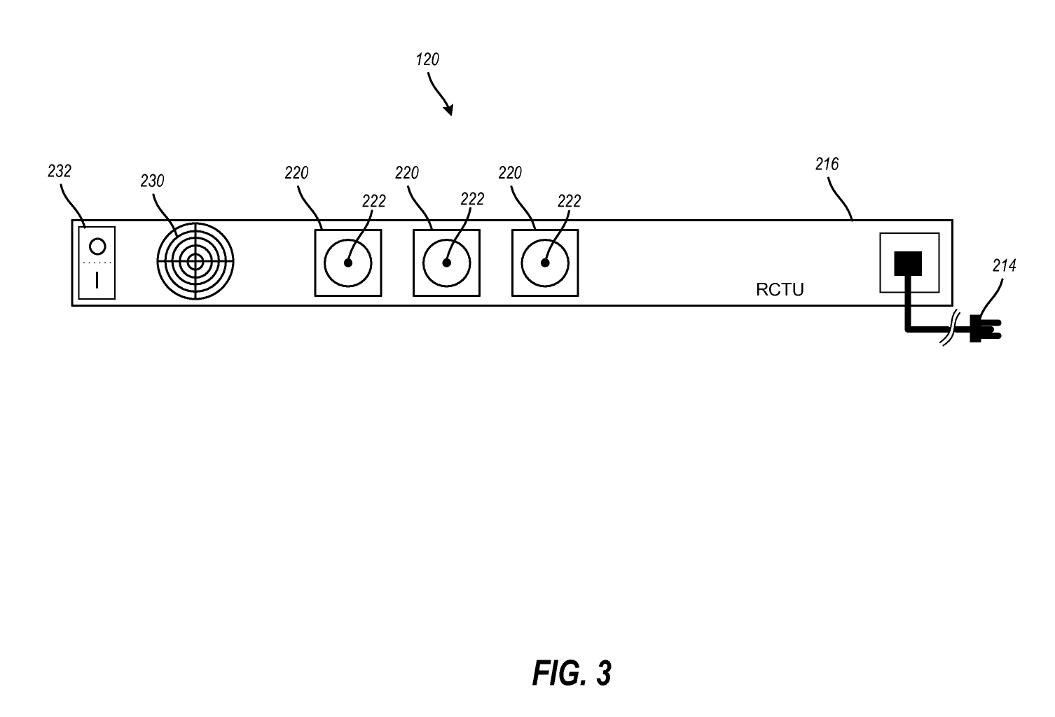

Referring now to FIG. 3, a rear view of the uncovered Remote Call Testing Unit (RCTU) 120 of FIG. 2 is shown. The wireless E-911 call testing system 100 includes such a Remote Call Testing Unit (RCTU) 120 located at a wireless carrier's cellular tower site. The RCTU 120 is, for example, housed in a rack mount case (19 inch) 216 within the cabinet of the wireless carrier's cell site. The RCTU 120 further includes an external power switch 232. The RCTU 120 is, for example, powered by a standard 120V power supply 210 and 120V power input cable 214. The RCTU 120 also includes a cooling fan unit 230 to keep the RCTU 120 from overheating. The RCTU 120 also includes one or more snap connectors 220, or the like, to accept one or more external antenna feeds 222.

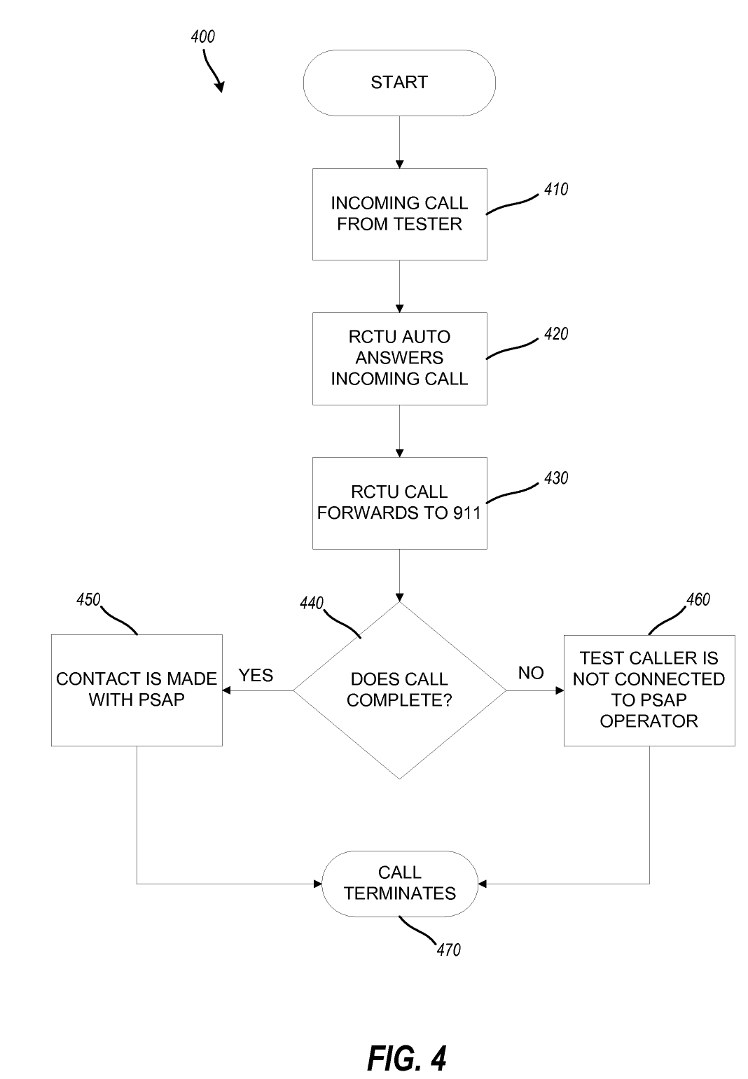

Referring now to FIG. 4, a flowchart diagram 400 is shown, illustrating one wireless E-911 call testing method. The wireless E-911 call testing method illustrates, in particular, the unavailability of or the integration failure of an automated emergency operator server. A user/call tester begins by dialing a 10-digit number assigned to the RCTU in step 410. The 10-digit number assigned to the RCTU is predetermined by the carrier. A Mobile Phone Unit (MPU) located within the RCTU will auto answer the incoming call from the tester in step 420. Once the incoming call is answered by the MPU, the processor will perform the following AT command functions, in step 430, to place the current call on hold and dial 911 then join both calls: ATDT911; (places the incoming call on hold then dials 911) and AT+CHLD=3 (connects both calls). An inquiry is made into whether the call was completed in step 440. If the call was successfully completed, the call tester will verify the E911 data with PSAP operator in step 450. If the call was not successfully completed, the call tester will not connect with the PSAP operator, in step 460, due to a lack of data integrity in the mobile switching center (MSC) translations, the PSTN network, or combination of the networks. The call terminates in step 470.

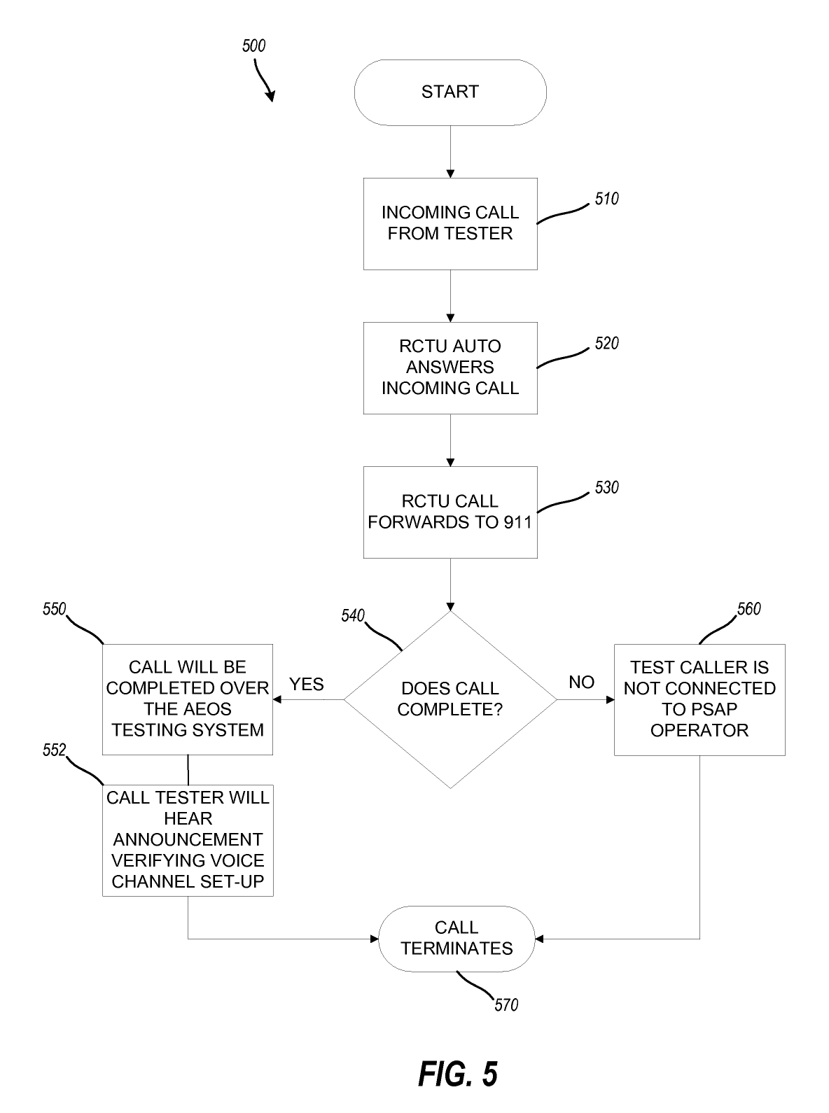

Referring now to FIG. 5, a flowchart diagram 500 is shown, according to another embodiment of the technology, and illustrating one wireless E-911 call testing method with the integration of the automated emergency operator server. A user/call tester begins by dialing a 10-digit number assigned to the RCTU in step 510. The 10-digit number assigned to the RCTU is predetermined by the carrier. A Mobile Phone Unit (MPU) located within the RCTU will auto answer the incoming call from the tester in step 520. Once the incoming call is answered by the MPU, the processor will perform the following AT command functions, in step 530, to place the current call on hold and dial 911 then join both calls: ATDT911; (places the incoming call on hold then dials 911) and AT+CHLD=3 (connects both calls). An inquiry is made into whether the call was completed in step 540. If the call was successfully completed, the incoming test call will route over existing networks (including for example, landline and/or mobile) to the AEOS system in step 550. The AEOS system then transmits an audible message to call tester verifying voice channel set-up in step 552. If the call was not successfully completed, the call tester will not connect with the PSAP operator, in step 560, due to a lack of data integrity in the mobile switching center (MSC) translations, the PSTN network, or combination of the networks. This lack of data integrity will be obvious due to audible high/low tones or a recording from wireless carrier or PSTN. The call terminates in step 570.

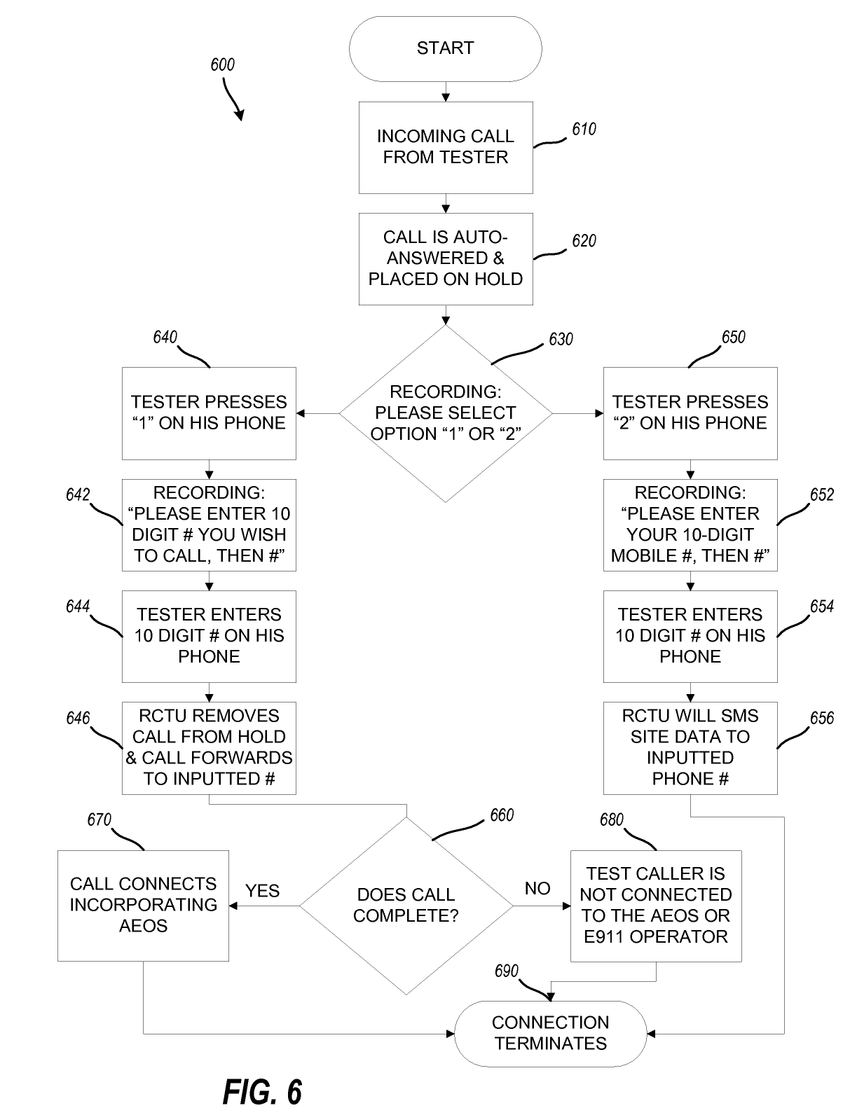

Referring now to FIG. 6, a flowchart diagram 600 is shown, according to another embodiment of the technology, and illustrating one wireless E-911 call testing method with the integration of the automated emergency operator server. A user/call tester begins by dialing a 10-digit number assigned to the RCTU in step 610. The 10-digit number assigned to the RCTU is predetermined by the carrier. The RCTU will auto answer the incoming call and place it on hold via an AT command string in step 620. The processor within the RCTU prompts the call tester to select either option 1 or 2 in step 630. Option 1 executes a test call. Option 2 provides the call tester the ability to receive an SMS message from the MPU showing the CGI data of the subject cell site.

If the call tester selects Option 1, in step 640, the call tester is presented in step 642 with a one of a prerecorded message or a tone asking for the 10-digit number the call tester wishes to test call. The one of a prerecorded message or a tone is issued by the processor within the RCTU. In step 644 the call tester inputs the 10-digit number from the key pad of the phone, and presses #. Upon receipt of the 10-digit number, and using AT command strings, the processor within the RCTU, in step 646, will remove the call from hold and execute the following functions which will remove the call from hold, dial the subject (test) number, and join both calls: AT+CHLD=3 (connects both calls). An inquiry is made into whether the call was completed in step 660. If the call was successfully completed, the call is routed over existing networks (landline and mobile) to the AEOS system, in step 670, and the AEOS system sends an audible message to call tester verifying the voice channel set-up. If the call was not successfully completed, the call tester will not connect with the PSAP operator or the AEOS, in step 680, due to lack of integrity in the MSC translations, PSTN network, or a combination of the networks. This lack of data integrity will be obvious due to audible high/low tones or a recording from wireless carrier or PSTN. This call, originating with the tester selecting Option 1 in step 640, terminates in step 690.

If the call tester selects Option 2, in step 650, the call tester is presented in step 652 with one of a prerecorded message or a tone asking for the 10-digit number at which the call tester wishes to receive an SMS response message. The one of a prerecorded message or a tone is issued by the processor within the RCTU. In step 654 the call tester inputs the 10-digit number from the key pad of the phone, and presses #. Upon receipt of the 10-digit number, the processor within the RCTU, in step 656, initiates the SMS message using AT command strings and sends the SMS message to the destination number previously inputted by the call tester. CGI data will be sent in the SMS along with signal levels of the subject cell site. This call, originating with the tester selecting Option 2 in step 650, terminates in step 690.

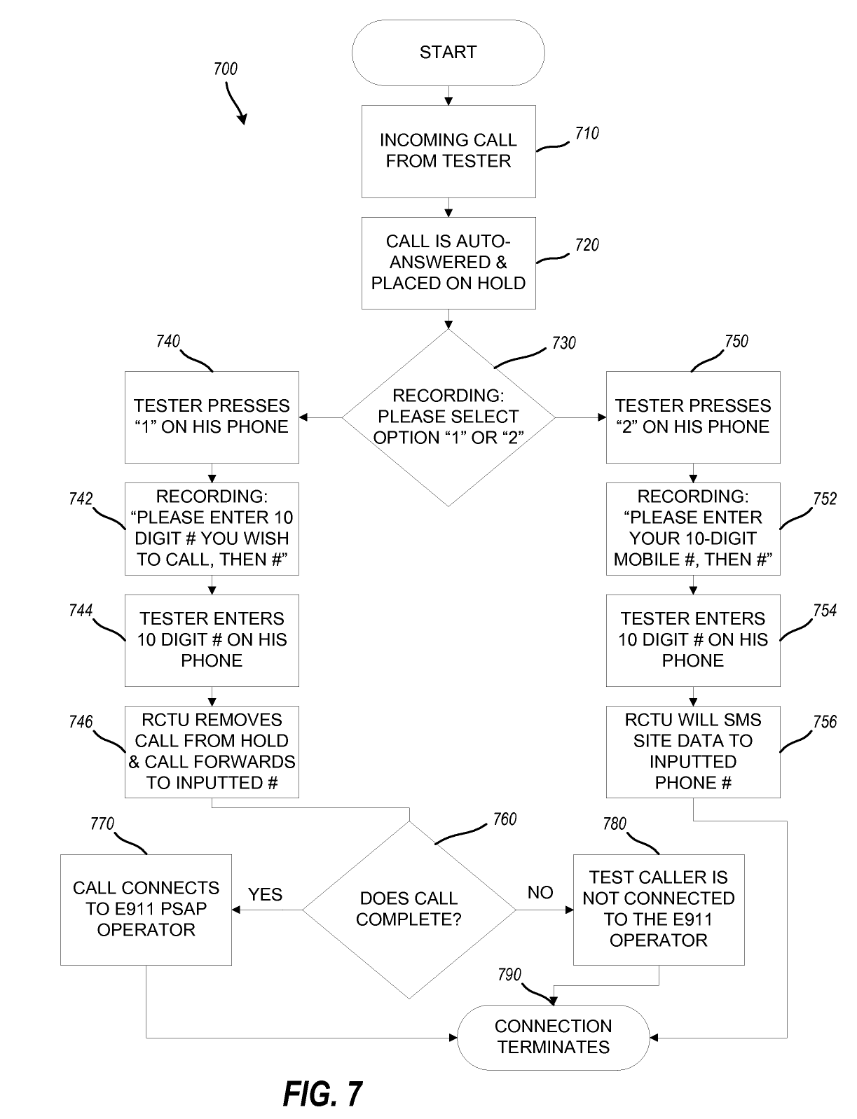

Referring now to FIG. 7, a flowchart diagram 700 is shown, according to yet another embodiment of the technology, and illustrating one wireless E-911 call testing method illustrating the unavailability of or the integration failure of an automated emergency operator server. A user/call tester begins by dialing a 10-digit number assigned to the RCTU in step 710. The 10-digit number assigned to the RCTU is predetermined by the carrier. The RCTU will auto answer the incoming call and place it on hold via an AT command string in step 720. The processor within the RCTU prompts the call tester to select either option 1 or 2 in step 730. Option 1 executes a test call. Option 2 provides the call tester the ability to receive an SMS message from the MPU showing the CGI data of the subject cell site.

If the call tester selects Option 1, in step 740, the call tester is presented in step 742 with one of a prerecorded message or a tone asking for the 10-digit number the call tester wishes to test call. The one of a prerecorded message or a tone is issued by the processor within the RCTU. In step 744 the call tester inputs the 10-digit number from the key pad of the phone, and presses #. Upon receipt of the 10-digit number, and using AT command strings, the processor within the RCTU, in step 746, will remove the call from hold and execute the following functions which will remove the call from hold, dial the subject (test) number, and join both calls: AT+CHLD=3 (connects both calls). An inquiry is made into whether the call was completed in step 760. If the call was successfully completed, the call is routed over existing networks (landline and mobile) to an E911 PSAP operator in step 770. The call tester will verify E911 data with the PSAP operator. The call subsequently terminates in step 790. If the call was not successfully completed, the call tester will not connect with E911 PSAP operator, in step 780, due to lack of integrity in the MSC translations, PSTN network, or a combination of the networks. This lack of data integrity will be obvious due to audible high/low tones or a recording from wireless carrier or PSTN. This call, originating with the tester selecting Option 1 in step 740, terminates in step 790.

If the call tester selects Option 2, in step 750, the call tester is presented in step 752 with one of a prerecorded message or a tone asking for the 10-digit number at which the call tester wishes to receive an SMS response message. The one of a prerecorded message or a tone is issued by the processor within the RCTU. In step 754 the call tester inputs the 10-digit number from the key pad of the phone, and presses #. Upon receipt of the 10-digit number, the processor within the RCTU, in step 756, initiates the SMS message using AT command strings and sends the SMS message to the destination number previously inputted by the call tester. CGI data will be sent in the SMS along with signal levels of the subject cell site. This call, originating with the tester selecting Option 2 in step 750, terminates in step 790.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A wireless E-911 call-testing method for verifying 911 call functionality without the need for in-person, on-site testing at each cellular site in a wireless carrier network, the method comprising:
initiating a test call from a remote location by accessing a number assigned to a remote call-testing apparatus, the remote call-testing apparatus located within a wireless carrier's cellular tower site base station to automatically answer an incoming emergency 911 test call, dial 911 in a new call, combine the two calls into a single combined call, and to subsequently reroute the combined call to a Public Safety Answering Point (PSAP);
answering automatically the test call at the remote call-testing apparatus;
dialing 911 in a new call at the remote call-testing apparatus;
combining the test call and the 911 call into a single call at the remote call-testing apparatus;
routing the combined call to a Public Safety Answering Point (PSAP); and
wherein verification of 911 call functionality is completed without the need for in-person, on-site testing at each cellular site

2. The wireless E-911 call-testing method of claim 1, further comprising:
answering automatically the test call with a mobile phone unit located within the remote call-testing apparatus;
dialing 911 in a new call with a processor located within the remote call-testing apparatus;
combining the test call and the 911 call into a single call with the processor located within the remote call-testing apparatus; and
rerouting the combined call to a Public Safety Answering Point (PSAP) with the processor located within the remote call-testing apparatus.

3. The wireless E-911 call-testing method of claim 1, further comprising:
utilizing an Automated Emergency Operator Server (AEOS), to electronically and automatically act as an emergency operator having access to E911 critical databases; and
wherein the AEOS is contacted by the RCTU via a unique a routing number over a dedicated trunk.

4. The wireless E-911 call-testing method of claim 3, further comprising:
identifying, at the AEOS, the call-back number and the E911 location data from an existing PSAP database; and
transmitting, from the AEOS, the E911 location data via a web client to a graphical user interface (GUI) for the call tester to verify.

5. The wireless E-911 call-testing method of claim 3, further comprising:
presenting, via the AEOS and a return data path, the following E911 data to a user/call tester: a unique routing number, a physical address of the RCTU, a latitude and a longitude of the RCTU, and a calling number of the call tester.

6. The wireless E-911 call-testing method of claim 3, further comprising:
establishing a voice channel, via the public switched telephone network (PSTN);
representing the voice channel in a return path for voice channel setup verification; and
transmitting a verification to the test caller verifying voice channel integrity.

7. A wireless E-911 call-testing method, for verifying 911 call functionality without the need for in-person, on-site testing at each cellular site in a wireless carrier network, the method comprising:
initiating a test call from a remote location by accessing a number assigned to a remote call-testing apparatus, the remote call-testing apparatus located within a wireless carrier's cellular tower site base station to automatically answer an incoming emergency 911 test call, dial 911 in a new call, combine the two calls into a single combined call, and to subsequently reroute the combined call to a Public Safety Answering Point (PSAP);
answering automatically the test call at the remote call-testing apparatus and placing the test call on hold;
placing the test call on hold via an AT command string at the remote call-testing apparatus;
prompting audibly a test caller to select one of two options, wherein the test caller selects one of: entering 1, to execute a test call, or entering 2, to provide the test caller with an SMS message from the remote call-testing apparatus displaying test results data from the wireless carrier's cellular tower site.

8. The wireless E-911 call-testing method of claim 7, further comprising:
answering automatically the test call with a mobile phone unit located within the remote call-testing apparatus;
placing, with a processor located within the remote call-testing apparatus, the test call on hold via an AT command string at the remote call-testing apparatus;
prompting, with a processor located within the remote call-testing apparatus, audibly a test caller to select one of two options, wherein the test caller selects one of: entering 1, to execute a test call, or entering 2, to provide the test caller with an SMS message from the remote call-testing apparatus displaying test results data from the wireless carrier's cellular tower site.

9. The wireless E-911 call-testing method of claim 7, further comprising:
selecting 1, by the test caller when prompted, thus executing a test call process;
prompting the test caller with one of a prerecorded message or a tone, issued by the remote call-testing apparatus, to enter a 10-digit number, the number being a telephone number to be tested;
entering the 10-digit number, by the test caller;
removing, at the remote call-testing apparatus, the automatically answered test call from hold;
executing, at the remote call-testing apparatus, AT command functions and combining the automatically answered test call and a call with the 10-digit number entered;
confirming, at the remote call-testing apparatus, whether the combined call was completed successfully; and
routing, at the remote call-testing apparatus, the combined call to a Public Safety Answering Point (PSAP) operator.

10. The wireless E-911 call-testing method of claim 7, further comprising:
selecting 2, by the test caller when prompted, thus initiating a test call process;
prompting the test caller with one of a prerecorded message or a tone, issued by the remote call-testing apparatus, to enter a 10-digit number, the number being a telephone number of a calling device of the test caller to which the caller wishes to receive an SMS message;
entering the 10-digit number, by the test caller;
initiating, at the remote call-testing apparatus, the SMS message, using AT command strings;
sending, from the remote call-testing apparatus, the SMS message to the entered 10-digit number, the SMS message containing CGI data and signal levels of the wireless carrier's cellular tower site base station.

11. The wireless E-911 call-testing method of claim 7, further comprising:
selecting 1, by the test caller when prompted, thus executing a test call process;
prompting the test caller with one of a prerecorded message or a tone, issued by the remote call-testing apparatus, to enter a 10-digit number, the number being a telephone number to be tested;
entering the 10-digit number, by the test caller;
removing, at the remote call-testing apparatus, the automatically answered test call from hold;
executing, at the remote call-testing apparatus, AT command functions and combining the automatically answered test call and a call with the 10-digit number entered;
confirming, at the remote call-testing apparatus, whether the combined call was completed successfully; and
routing, at the remote call-testing apparatus, the combined call to a an Automated Emergency Operator Server (AEOS), to electronically and automatically act as an emergency operator having access to E911 critical databases; and
routing to a Public Safety Answering Point (PSAP) operator when the AEOS is offline or otherwise unavailable.

12. A wireless E-911 call-testing system, for verifying 911 call functionality without the need for in-person, on-site testing at each cellular site in a wireless carrier network, the system comprising:
a remote call-testing apparatus, the remote call-testing apparatus located within a wireless carrier's cellular tower site base station to automatically answer an incoming emergency 911 test call, dial 911 in a new call, combine the two calls into one, and to subsequently reroute the combined call to a Public Safety Answering Point (PSAP);
a remote calling device, the remote calling device selectively connected to the remote call-testing apparatus to conduct the incoming emergency 911 test call;
wherein verification of 911 call functionality is completed without the need for in-person, on-site testing at each cellular site.

13. The wireless E-911 call-testing system of claim 12, the remote call-testing apparatus further comprising:
one or more of a mobile phone unit (MPU), located within the remote call-testing apparatus, the one or more MPU being operative to automatically answer an incoming emergency 911 test call; and
a processor, located within the remote call-testing apparatus, the processor to perform AT command functions to place the incoming emergency 911 test call on hold, dial 911, and subsequently join both calls.

14. The wireless E-911 call-testing system of claim 12, further comprising:
an Automated Emergency Operator Server (AEOS), and to electronically and automatically act as an emergency operator having access to E911 critical databases.

15. The wireless E-911 call-testing system of claim 14, wherein the AEOS is contacted by the RCTU via a unique a routing number over a dedicated trunk.

16. The wireless E-911 call-testing system of claim 14, wherein the AEOS returns, via a data path, presenting the following E911 data to a user/call tester: a unique routing number, a physical address of the RCTU, a latitude and a longitude of the RCTU, and a calling number of the call tester.

17. The wireless E-911 call-testing system of claim 13, wherein the remote call-testing apparatus further comprises:
one or more of an antenna connector; and
one or more of an antenna feed, entering the remote call-testing apparatus through the one or more of an antenna connector; and
wherein the one or more of an antenna feed electronically connects to the one or more of a mobile phone unit (MPU), located within the remote call-testing apparatus.

18. The wireless E-911 call-testing system of claim 13, wherein the remote call-testing apparatus further comprises:
a cooling fan unit, located with remote call-testing apparatus, providing cool air to the one or more mobile phone units (MPU), located within the remote call-testing apparatus, and the processor, located within the remote call-testing apparatus.

19. The wireless E-911 call-testing system of claim 13, wherein the remote call-testing apparatus further comprises:
a power supply, the power supply providing power to the MPUs and to the processor located within the remote call-testing apparatus.
